(19) United States
(12) Patent Application Publication
(10) Pub. No.: US 2009/0288940 A1
(43) Pub. Date: Nov. 26, 2009

(54) Distillation Process

(76) Inventors: Michael R. Smith, Rolling Meadows, IL (US); Gavin P. Towler, Inverness, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/123,587

(22) Filed: May 20, 2008

(51) Int. Cl. B01D 3/14; B01D 3/32

(52) U.S. Cl. 203/71; 203/75; 203/99

(57) ABSTRACT

The process employs at least two distillation zones located within a column shell to produce an overhead and bottoms product from the first distillation zone and an intermediate product from the second distillation zone. Fluid is withdrawn from a side draw stage in the first distillation zone and passed through a conduit to the second distillation zone. A partition envelopes the second distillation zone to prevent mass transfer with the first distillation zone proximate the partition. The second distillation zone may be located relative to the first distillation zone to benefit from heat transfer across the partition.

### FIELD OF THE INVENTION

This invention relates to distillation processes used to produce at least three outlet streams. More specifically the invention relates to distillation processes involving at least two distillation zones within a single column shell.

### BACKGROUND OF THE INVENTION

Many industries such as petrochemical, chemical and petroleum refining use distillation columns for separating mixtures. Such columns are typically cylindrical, vertically orientated vessels wherein rising vapor and descending liquid come into contact, transfer components, separate, and pass respectively towards the top and bottom sections of the column. Contacting and separation of the vapor and liquid phases is enhanced by the use of vapor-liquid contacting devices such as trays and packing, each of which are know to vary widely in design. The specific operating conditions of individual distillation columns may vary significantly in order to accomplish the myriad separations for the vastly different mixtures that are processed. Distillation columns may be operated in either batch or continuous mode. When a multicomponent mixture is to be separated into more than two product streams a wide variety of configurations may be used. Examples include simply taking an additional product stream from a vapor-liquid contacting stage (a rough side cut); linking multiple distillation columns together such as shown in U.S. Pat. No. 7,172,686 and U.S. Pat. No. 6,106,674; creating multiple distillation sections or zones within a single column such as shown in U.S. Pat. No. 6,250,106; and combinations thereof.

Commonly, heat is supplied or removed from the column by removing a stream from the column, passing it through a heat exchanger external to the column shell, and returning at least part of the stream thus cooled or heated to the column. For example, overhead vapor may be withdrawn from the upper section of the column and passed to an overhead system outside the column shell where it is condensed or partially condensed in a heat exchanger. A portion or all of the condensed liquid may be returned to the column to provide reflux. Similarly, heat exchangers are commonly used to provide vapor to the column by heating a liquid stream removed from the lower section of the column and returning a stream comprising vapor. Heat may also be added to and/or removed from intermediate locations in a distillation column. The use of heat exchanges located within a column shell is also known.

Fractional distillation is a well developed unit operation, which is used extensively to separate a wide variety of chemical compounds. This prominence and the significant capital and operating costs associated with distillation continue to provide incentive to develop improved equipment and procedures which provide benefits such as lower capital and operating costs, increased flexibility for integrating multiple units, and enabling difficult separations. Although a wide variety of distillation apparatus are known, there is always a demand for improvements which provide more effective use of capital and/or operating expenses to obtain the separation desired.

### SUMMARY OF THE INVENTION

The present invention is a distillation method employing a single column to produce at least three outlet streams. In an embodiment, the distillation method comprises passing a multicomponent feed stream into a first distillation zone located within the column shell. Ascending vapor and descending liquid are contacted and separated in multiple vapor-liquid contacting stages in the first distillation zone to produce an overhead stream and a bottoms stream which are discharged from the first distillation zone. A fluid is withdrawn from a side draw stage located within the first distillation zone. At least a portion of the withdrawn fluid is passed through a first conduit and into a second distillation zone located within the column shell. The second distillation zone is defined by a partition, which prevents mass transfer between the first and second distillation zones proximate the partition. Ascending vapor and descending liquid are contacted and separated in multiple vapor-liquid contacting stages in the second distillation zone to produce an intermediate stream which is discharged from the second distillation zone.

In an embodiment, the method also comprises passing a second fluid from the second distillation zone to the side draw stage. In another embodiment, the method comprises adjusting the temperature of a portion of the intermediate stream and returning a portion of the temperature adjusted intermediate stream to the second distillation zone. The method also encompasses embodiments wherein a portion of the second distillation zone reboiler or condenser duty is obtained from the first distillation zone. Other embodiments of the present invention encompass further details the descriptions of which, including preferred and optional features and their arrangement are hereinafter disclosed.

Thus, in one aspect the invention provides more flexible process by enabling separation of the second distillation zone from the side draw stage. In another aspect, the invention enables obtaining a portion of the second distillation zone duty from the first distillation zone, independent of the location of the side draw stage. In addition, the invention may require less utilities to operate, less capital costs, and plot space to construct.

### BRIEF DESCRIPTION OF THE DRAWINGS

FIGS. 1 -5 are simplified schematic diagrams of various embodiments of the present invention.

The Figures are intended to be illustrative of the present invention and are not intended to limit the scope of the invention as set forth in the claims. The drawings are simplified schematic views, not to scale, showing components of the distillation column helpful for an understanding of the invention. Details, well known in the art, such as pumps, control valves, instrumentation, heat-recovery circuits, and similar hardware which are non-essential to an understanding of the invention are not illustrated.

### DETAILED DESCRIPTION OF THE INVENTION

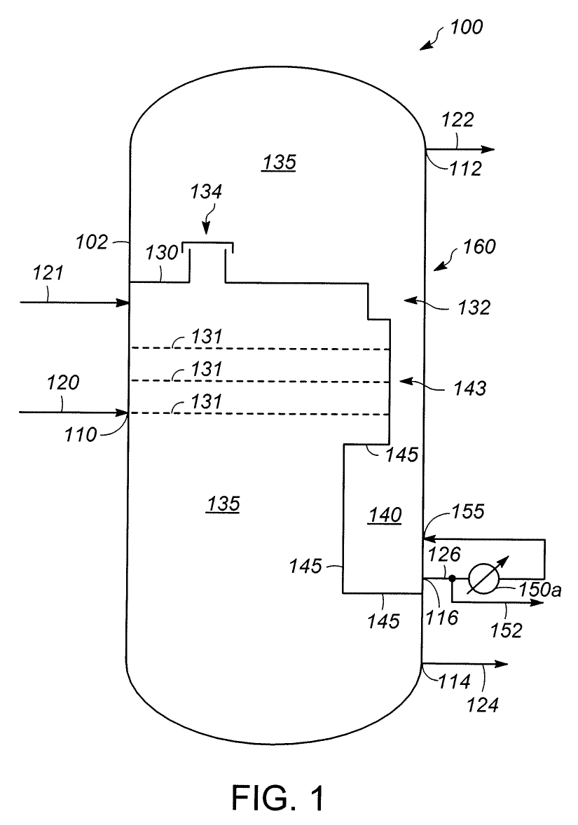

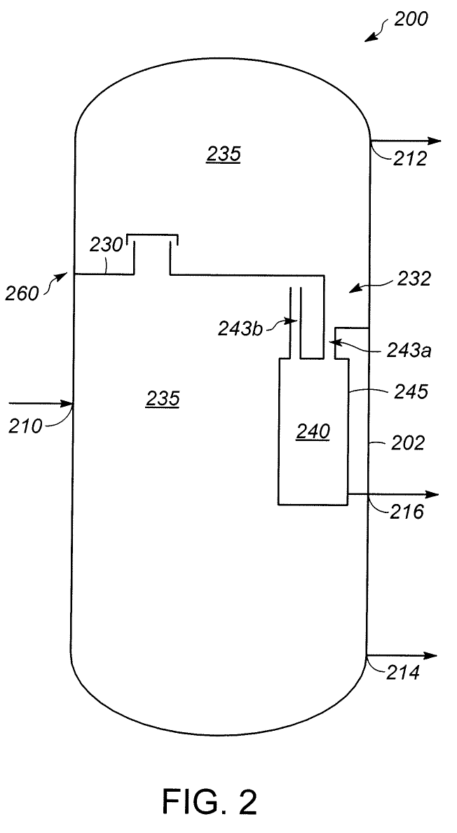

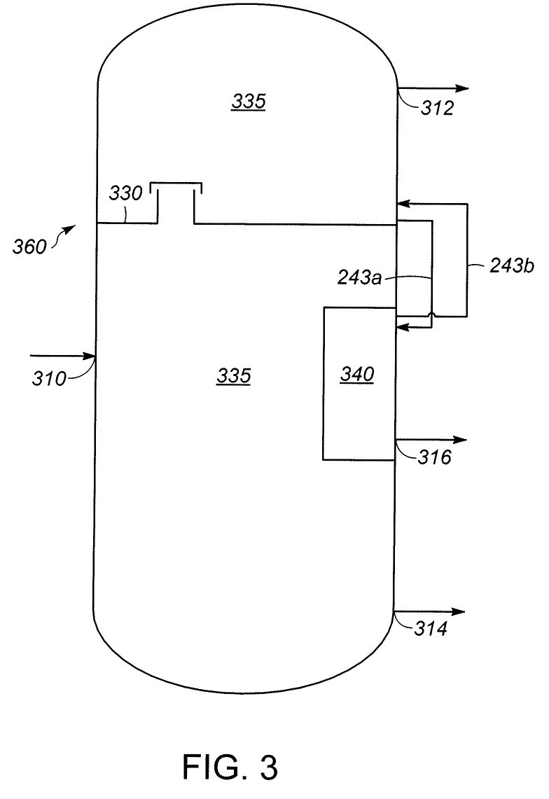

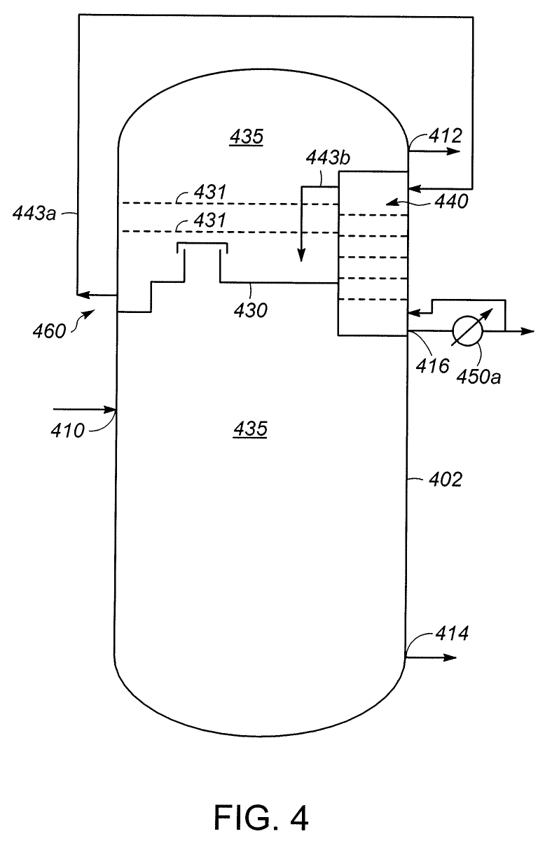

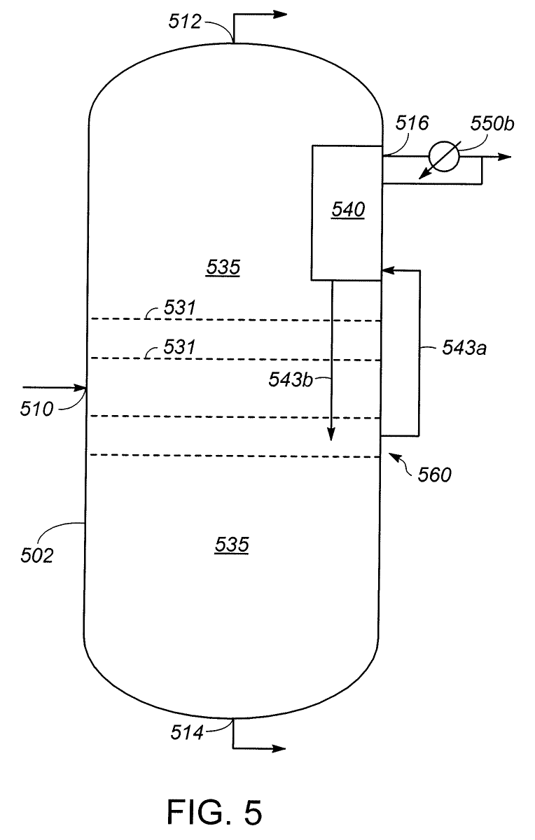

The instant invention is a distillation apparatus for separating a multicomponent feed into at least three product or outlet streams. In an embodiment illustrated in FIG. 1, the distillation column 100 has a shell 102 which includes at least a feed inlet 110, an overhead outlet 112, a bottoms outlet 114, and an intermediate outlet 116. The inlets and outlets of the shell may connect to process lines or conduits which introduce or remove fluid from the column. Thus, the feed carried by conduit 120 passes into the first or primary distillation zone 135 within distillation column shell 102 through feed inlet 110. Likewise, an overhead stream produced in the first distillation zone 135 is discharged through overhead outlet 112 and conduit 122. A bottoms stream produced in the first distillation zone 135 is discharged through bottoms outlet 114 and conduit 124. The overhead outlet 112 may be located in the top portion of the column. Likewise, bottoms outlet 114 may be located in the bottom portion of the column. The top portion of the column extends from the uppermost portion of the column shell downward for one-third of the column height and the bottom portion of the column extends upward from the lowermost portion of the column shell for one-third of the column height. In the same manner, the top and bottom portions of distillation zones refer to the upper and lower one-third heights of the zones. The overhead outlet 112 and bottoms outlet 114 may be in fluid communication with overhead and bottoms systems (not shown) that provide cooling and heating of the first distillation zone. The heating and cooling systems may vary considerably as is well known in the art. For example, they may be wholly or partially located within the column and they may return a portion of the respective streams to the column. The overhead system may condense a portion of the overhead stream to return liquid to the first distillation zone while the bottoms system may vaporize a portion of the bottoms stream to return vapor to the first distillation zone. Portions of product streams that are not returned to the column are referred to as net product streams. The term “a portion of” as used herein means a part of the stream, material, or object up to and including the entire stream, material, or object. Thus, the foregoing description encompasses both embodiments of returning none and returning all of the streams to the column.

A second distillation zone 140 is located within the column shell 102. The second distillation zone 140 is substantially enveloped by a partition 145 which separates the first distillation zone 135 from the second distillation zone 140 preventing mass transfer between the two zones proximate the partition 145. Thus, the second distillation is defined by the partition. It is recognized that the partition includes openings that are in fluid communication with the conduits that enable mass transfer between the second distillation zone and other locations in the first distillation zone reached by the conduits distant from the partition.

That is, there is no significant mass transfer directly across the boundary between the first and second distillation zones. The fabrication practices and tolerances for the invention are consistent with those employed in the art. Thus, it is recognized that there may be small leaks such as through weep holes intentionally placed to enable the equipment to drain during shut down and minor gaps where fluid tight seals are imperfect. The degree to which such imperfections are tolerated vary based on the specifics of the operations. For example, ultra pure fine chemical separations require no or fewer leaks than rough cuts of crude oil that will be processed multiple times before it meets final product specifications. The same tolerances used by those of ordinary skill in the art may be employed in the invention to meet the operating requirements of specific separations.

Each of the first and second distillation zones include multiple, that is, at least two vapor-liquid contacting stages wherein ascending vapor and descending liquid are brought together for contacting and are separated to enable each stream to continue in its upward or downward direction. A side draw stage 160 is located within the first distillation zone 135 and may comprise trap-out tray 130. Trap-out tray 130 separates a portion of fluid from the first distillation zone. Such devices are well known in the art and may be complete or partial trap-out trays. That is, the trap-out tray 130 facilitates withdrawal of a portion of at least one of the vapor and liquid from the side draw stage. In the embodiment illustrated in FIG. 1, trap-out tray 130 blocks all downwardly flowing liquid while allowing the upward flow of vapor such as through one or more chimneys 134 through the tray. That is, all of the liquid collected from the first distillation zone 135 at the side draw stage may be introduced into the second distillation 140 zone. In such an embodiment, it is highly preferred that an optional stream be introduced into the first distillation zone below trap-out tray 130, e.g through conduit 121, to provide liquid for contacting vapor below the trap-out tray. The optional stream may be, for example, another feed stream to the column, or material routed from another portion of the column, including material routed from other distillation zones. Preferably trap-out tray 130 comprises a liquid sump 132 to facilitate collection of the liquid in the side draw stage 160. In another embodiment, a portion of the liquid passes through the trap-out tray to the next lower contacting stage. Thus, liquid partially or completely blocked may collect on trap-out tray 130. At least a portion of the liquid collected in the side draw stage 160 is withdrawn, passes through conduit 143 and enters the second distillation zone 140. Optionally, a portion of the withdrawn liquid may be passed or distributed to one or more destinations inside and/or outside the distillation column 100. Thus, in an embodiment all of the liquid flowing down the first distillation zone 135 may be blocked by trap-out tray 130 and withdrawn from side draw stage 160. A first portion of the withdrawn liquid passes through conduit 143 into the second distillation zone 140, and a second portion of the withdrawn liquid passes to the first distillation zone 135 below the trap-out tray 130. In an embodiment a portion of the liquid flowing down the first distillation zone 135 passes through trap-out tray 130 while a second portion is trapped out, withdrawn from side draw stage 160 and passes through conduit 143 into the second distillation zone 140. Optionally, a first portion of the withdrawn liquid passes through conduit 143 into the second distillation zone 140 and a second portion of the withdrawn liquid passes to a third distillation zone (not shown) within the column 100.

As illustrated in FIG. 1, the column shell 102 may serve to define a portion of the conduit 143 and/or the second distillation zone 140. Conduit 143 may also provide fluid communication of the vapor from the top of the second distillation zone 140 to the side draw stage 160. Vapor-liquid contacting devices, e.g. trays and packing, and other devices such as heat exchangers and beds of catalyst may be used individually or in any combination in the first and/or second distillation zones. The specific form and details of such devices in the column are non-essential for the purposes of the subject invention and are not generally illustrated herein. As is well known in the art, each tray provides one real vapor-liquid contacting stage, which includes a portion of the spacing above and below the tray. Thus, a stage N may include the volume in the distillation zone from a horizontal plane midway between tray N and tray N−1 to a horizontal plane midway between tray N and tray N+1. The number of real vapor-liquid contacting stages required for a given separation is equal to the number of theoretical distillation stages required, divided by the stage efficiency of the trays that are used, as is well known by those skilled in the art. The stage efficiency depends on the type of tray, tray design parameters and fluid properties. Likewise, when packing is used, a specific height of packing is equivalent to one theoretical distillation stage. This height is known as the Height Equivalent to a Theoretical Plate (HETP) and varies for each type of packing and process service as well known by those of ordinary skill in the art.

As illustrated in FIG. 1, the invention enables the second distillation zone 140 to be located independently of the side draw stage 160. By varying the configuration of the conduit, the second distillation zone may be located in the column as desired. The second distillation zone 140 may be vertically spaced apart from the side draw stage so that neither the trap-out tray nor the side draw stage defines a portion of the second distillation zone boundary. In an embodiment, the second distillation zone is separated from the side draw stage by one or more real vapor-liquid contacting stages 131 of the first distillation zone. That is, to provide fluid communication between the side draw stage and the second distillation zone, conduit 143 may traverse one or more vapor-liquid contacting stages of the first distillation zone. The use of conduits provides an additional advantage in that the first distillation zone has a greater effective diameter, because the full diameter of the second distillation zone does not extend to the side draw stage. The cross-sectional area of the conduit is less than the cross-sectional area of the second distillation zone. In an embodiment, the cross-sectional area of the conduit is less than about half the cross-sectional area of the second distillation zone. Thus, a greater cross-sectional area of the column is available for vapor-liquid contacting in the first distillation zone.

In an embodiment, a portion of the second distillation zone 140 reboiler duty may be obtained from heat available in the first distillation zone 135. The lowermost portion of the second distillation zone 140, as defined by the lowermost portion of partition 145, may be located adjacent a portion of the first distillation zone 135 having a temperature that is at least about 10° C. higher than the reboiler temperature of the second distillation zone. In another embodiment, the temperature of the first distillation zone adjacent the lowermost portion of the second distillation zone is at least about 20° C., higher than the second distillation zone bottoms temperature, and in another embodiment, this temperature difference is at least about 30° C. Partition 145 may thus serve to transfer heat between the first and second distillation zones. In this embodiment, heat is transferred from the first distillation zone 135 to the second distillation zone 140. The partition 145 may be adapted to enhance the desired heat transfer. For example, the partition may comprise heat transfer fins, heat pipes, dimpled and/or fluted surfaces, and porous boiling surfaces such as those described in U.S. Pat. No. 3,384,154; U.S. Pat. No. 4,232,056). In an embodiment, the partition 145 may be insulated to reduce transfer between the first and second distillation zones. In an embodiment, a first portion of partition 145 may be adapted to increase heat transfer and a second portion of partition 145 may be adapted to inhibit heat transfer. Heat transfer may be inhibited, for example, by applying insulating material known in the art to the partition. Heat transfer may also be inhibited by constructing the partition or a portion of it using a less thermally conductive material. Use of double wall construction with insulation or simply spacing between the double walls may also be used to minimize heat transfer where desired. In the embodiment illustrated in FIG. 1 the partition defining the bottom portion of the second distillation zone may be adapted to enhance heat transfer from the first distillation zone to the second distillation zone while the partition defining the top portion of the second distillation zone may be adapted to minimize heat transfer between the two zones across the top portion of the partition.

In other embodiments, the second distillation zone may be located relative to the first distillation zone to obtain a certain percentage of the second zone heating or cooling requirement or duty. For example, one of ordinary skill in the art can readily determine the second distillation zone reboiler duty for the specific separation to be accomplished therein. In an embodiment, the first distillation zone provides at least 15% of the second distillation zone reboiler duty. That is, energy supplied to the second distillation zone from other sources such as heat exchanger 150a does not exceed 85% of the second distillation zone reboiler duty. In an embodiment, the first distillation zone provides at least 30% of the second distillation zone reboiler duty. That is, energy supplied to the second distillation zone from other sources does not exceed 70% of the second distillation zone reboiler duty. In an embodiment, the first distillation zone provides at least 50% of the second distillation zone reboiler duty. That is, energy supplied to the second distillation zone from other sources does not exceed 50% of the second distillation zone reboiler duty.

An intermediate stream is discharged from the second distillation zone 140 through intermediate outlet 116. As illustrated in FIG. 1, heat exchanger 150a in fluid communication with the second distillation zone may be used to supply a portion, including up to all, of the duty required to reboil the second distillation zone by heating and returning a portion, including up to all of the intermediate stream to the second distillation zone through inlet 155. A net intermediate product may be delivered via line 152. The term heat exchanger is used broadly to include direct and indirect exchanges including fired heaters. Heat exchanger 150a may not be necessary if sufficient heat may be obtained from the first distillation zone. However, use of heat exchanger 150a is preferred as it may improve the operating range and control of the equipment to obtain the desired separations even when the first distillation zone may provide all of the reboiler duty for some conditions. In an embodiment, a portion, including up to all, of the second distillation zone is located below the feed inlet 110. In an embodiment, the uppermost portion of the second distillation zone, as defined by the uppermost portion of the partition 145, is at least about 1 meter below the lowermost portion of the side draw stage. The side draw stage 160 maybe located above the feed inlet.

In the embodiment illustrated in FIG. 2, side draw stage 260 comprises trap-out tray 230. Liquid collected in sump 232 of the trap-out tray is withdrawn and passed via a first conduit 243a into the second distillation zone 240. Vapor from the second distillation zone is passed through a second conduit 243b to side draw stage 260. As illustrated, this vapor may be discharge below the trap-out tray 230. In another embodiment, conduit 243b may provide fluid communication through the trap-out tray to discharge the second distillation zone vapor into the liquid on the trap-out tray, or into the vapor space above the trap-out tray. FIG. 2 also illustrates that partition 245 may substantially enclose the second distillation zone 240 independent of the column shell 202. Thus, the partition may define the boundary of the second distillation zone. Such an arrangement may provide greater heat transfer and more uniform heating or cooling of the second distillation zone compare to embodiments wherein the column shell partially defines the partition. When multiple conduits are used, the total cross-sectional area of all the conduits may be less than the cross-sectional area of the second distillation zone. In an embodiment, the total cross-sectional area of all the conduits may be less than about half the cross-sectional area of the second distillation zone.

FIG. 3 illustrates an embodiment wherein the conduits 343a and 343b providing fluid communication between the side draw stage 360 and the second distillation zone 340 may be external to the column shell. The embodiment in FIG. 3 illustrates that the trap-out tray 330 may not require a sump. Liquid may be withdrawn directly from the upper surface of the tray and passed through conduit 343a into the second distillation zone 340. In FIGS. 1-3, it can be seen that the liquid withdrawn from the trap-out tray flows downward as it passes into the second distillation zone located below the side draw stage.

FIG. 4 illustrates an embodiment of the invention wherein a portion of the second distillation zone 440 is above the side draw stage 460 and another portion of the second distillation zone is below the side draw stage. In an embodiment, liquid withdrawn from trap-out trap 430 is passed via conduit 443a, external to the column shell, to the second distillation zone 440. Vapor from the second distillation zone is passed via conduit 443b, inside the column shell 402, to the side draw stage 460. The conduits 443a and 443b may pass through or by-pass one or more vapor-liquid contacting stages of the first distillation zone.

In the embodiment illustrated in FIG. 5, a vapor stream is withdrawn from side draw stage 560 and is passed upward to the second distillation zone 540 above the side draw stage via conduit 543a, external to the column shell 502. In an embodiment, conduit 543a may be located entirely within column shell 502. As shown the vapor passing side draw stage 560 may comprise a trap-out tray, or as illustrated, the side draw stage may be designed to enable vapor withdrawal from the stage without use of a trap-out tray. In the embodiment illustrated in FIG. 5, cooling of the second distillation zone overhead, such as to provide reflux may be provided by the lower temperature of the first distillation zone that is adjacent the top portion of the second distillation zone. That is, spacing the second distillation zone apart from the side draw stage may enable a portion of the overhead cooling duty of the second distillation zone to be obtained from the first distillation zone through heat transfer across the partition.

In an embodiment, the temperature of the first distillation zone adjacent the uppermost portion of the second distillation zone defined by the uppermost portion of the partition is at least 10° C. lower than the second distillation zone overhead temperature. In another embodiment, the first distillation zone temperature adjacent the uppermost portion of the second distillation zone is at least 20° C. lower than the second distillation zone overhead temperature and in another embodiment this temperature difference is at least 30° C.

In an embodiment, the first distillation zone provides at least 15% of the second distillation zone condenser duty. That is, energy removed from the second distillation zone from other sources such as heat exchanger 150b does not exceed 85% of the second distillation zone condenser duty. In an embodiment, the first distillation zone provides at least 30% of the second distillation zone condenser duty. That is, energy removed from the second distillation zone from other sources does not exceed 70% of the second distillation zone condenser duty. In an embodiment, the first distillation zone provides at least 50% of the second distillation zone condenser duty. That is, energy removed from the second distillation zone from other sources does not exceed 50% of the second distillation zone condenser duty.

As in other embodiments, a heat exchanger may be used to adjust the temperature of the intermediate stream and a portion of the temperature adjusted stream may be returned to the second distillation zone to provide the heating or cooling duty required for the specific embodiment. In the embodiment illustrated in FIG. 5, an overhead heat exchanger, i.e. a cooler 550b may be used to provide a portion, including up to all of the overhead cooling duty for the second distillation zone. Heat exchanger 550b, may condense a portion of the intermediate stream and return a portion of the intermediate stream to the second distillation zone. Liquid from the second distillation zone may be passed to the side draw stage via conduit 543b. As before, the partition may be enhanced to facilitate heat transfer where desired. In this embodiment the partition near the top portion of the second distillation zone may be enhanced to increase heat transfer. Likewise, in this embodiment the partition may be adapted to minimize heat transfer in the bottom portion of the second distillation zone.

The invention encompasses various combinations of the foregoing. Use of multiple side draw stages and more than two distillation zones in various combinations are contemplated. For example, in an embodiment two fluids may be withdrawn from one side draw stage in the first distillation zone and each fluid may be passed via separate conduits to separate distillation zones each of which is encompassed and defined by a partition as is described herein. In another embodiment, two fluid streams are withdrawn from separate side draw stages and are passed via separate conduits to separate distillation zones. That is, there may be a third, fourth, or more distillation zones similar to the “second” distillation zone described herein. These additional distillation zones may be arranged as needed to obtain the specific products desired. The invention may also be combined with other well know distillation practices such as catalytic distillation and dividing wall columns.

The following example compares the capital costs and plot space required to separate a hydrocracking unit product stream using a distillation column according to the invention and a prior art, two column apparatus comprising a main fractionation column and an external side stripper column. In both cases, the same feed was fractionated via computer simulation to produce a net overhead gasoline product, net bottoms diesel product, and a net intermediate product with the ASTM D-86 Distillation Curves, ° C. and Liquid Volume percent (LV %) yields as shown in Table 1.

TABLE 1
Product Yields and ASTM D-86 Distillations, ° C.

| D-86, ° C. | Overhead | Intermediate | Bottoms |
|---|---|---|---|
| IBP | 74 | 175 | 207 |
| 5% | 96 | 187 | 212 |
| 10% | 106 | 192 | 213 |
| 30% | 117 | 197 | 217 |
| 50% | 136 | 201 | 222 |
| 70% | 158 | 204 | 232 |
| 90% | 179 | 208 | 269 |
| 95% | 186 | 214 | 297 |
| EP | 193 | 220 | 323 |
| LV % yield | 50.8 | 5.4 | 43.8 |

For a feed rate of 20,000 barrels per stream day (BPSD) to the hydrocracking unit the Estimated Erected Capital Costs of the embodiment of the invention illustrated in FIG. 1 is 90% of the two column prior art configuration. In addition, the single shell, two zone column only requires approximately 67% of the plot space needed for the two-column system. It is anticipated that the invention also provides some reduction in utilities resulting from lower heat losses from transfer piping, equipment and insulated surfaces compared to the two-column system. Table 2 compares the physical dimensions of the columns in the two cases.

TABLE 2

| | |
|---|---|
| Prior art | Invention |

| Columns | Main | Side | Single Column |
|---|---|---|---|
| Total Trays | 53 | 10 | 53 (10) |
| Diameter, m | | | |
| Above Feed | 3.0 | 1.0 | 3.1 |
| Below Feed | 3.2 | 1.0 | 3.3 |
| Total Height, m | 41.8 | 8.8 | 41.8 |

| | | |
|---|---|---|
| Est. Erected Cost | Base | 0.9 * Base |
| Plot Space | Base | 0.67 * Base |

1. A method for distilling a multicomponent feed to produce at least three product streams, the method comprising:
a) passing a feed stream into a first distillation zone located within a column shell;
b) contacting and separating ascending vapor and descending liquid in multiple vapor-liquid contacting stages in the first distillation zone;
c) discharging an overhead stream from the first distillation zone;
d) discharging a bottoms stream from the first distillation zone;
e) withdrawing a first fluid from a side draw stage, the side draw stage being located within the first distillation zone;
f) passing at least a portion of the first fluid withdrawn from the side draw stage through a first conduit and into a second distillation zone located within the column shell, the second distillation zone being defined by a partition, the partition preventing mass transfer between the first and second distillation zones proximate the partition;
g) contacting and separating ascending vapor and descending liquid in multiple vapor-liquid contacting stages in the second distillation zone; and
h) discharging an intermediate stream from the second distillation zone;

2. The method of claim 1 further comprising passing a second fluid from the second distillation zone to the side draw stage.

3. The method of claim 2 wherein the second fluid passing from the second distillation zone to the side draw stage flows through a second conduit.

4. The method of claim 1 further comprising condensing at least a portion of the overhead stream to produce a condensate and returning at least a portion of the condensate to the first distillation zone.

5. The method of claim 1 further comprising heating at least a portion of the bottoms stream and returning at least a portion of the heated bottoms stream to the first distillation zone.

6. The method of claim 1 further comprising adjusting the temperature of at least a portion of the intermediate stream and returning at least a portion of the temperature adjusted intermediate stream to the second distillation zone.

7. A method for distilling a multicomponent feed to produce at least three product streams, the method comprising:
a) passing a feed stream into a first distillation zone located within a column shell;
b) contacting and separating ascending vapor and descending liquid in multiple vapor-liquid contacting stages in the first distillation zone;
c) discharging an overhead stream from the first distillation zone;
d) discharging a bottoms stream from the first distillation zone;
e) withdrawing a liquid stream from a side draw stage, the side draw stage being located within the first distillation zone;
f) passing at least a portion of the liquid stream withdrawn from the side draw stage through a first conduit and into a second distillation zone located within the column shell, the second distillation zone being defined by a partition and having a reboiler duty, the partition preventing mass transfer between the first and second distillation zones proximate the partition;
g) providing at least a portion of the second distillation zone reboiler duty from the first distillation zone through the partition;
h) contacting and separating ascending vapor and descending liquid in multiple vapor-liquid contacting stages in the second distillation zone;
i) passing vapor from the second distillation zone through a second conduit to the side draw stage; and
j) discharging an intermediate stream from the second distillation zone;

8. The method of claim 7 further comprising heating at least a portion of the intermediate stream and returning at least a portion of the heated intermediate stream to the second distillation zone.

9. The method of claim 7 wherein the liquid passing through the first conduit flows downwardly into the second distillation zone below the side draw stage.

10. The method of claim 9 further comprising obtaining at least 15% of the second distillation zone reboiler duty from the first distillation zone.

11. The method of claim 9 further comprising obtaining at least 30% of the second distillation zone reboiler duty from the first distillation zone.

12. A method for distilling a multicomponent feed to produce at least three product streams, the method comprising:
a) passing a feed stream into a first distillation zone located within a column shell;
b) contacting and separating ascending vapor and descending liquid in multiple vapor-liquid contacting stages in the first distillation zone;
c) discharging an overhead stream from the first distillation zone;
d) discharging a bottoms stream from the first distillation zone;
e) withdrawing a vapor stream from a side draw stage, the side draw stage being located within the first distillation zone;
f) passing at least a portion of the vapor stream withdrawn from the side draw stage through a first conduit and into a second distillation zone located within the column shell, the second distillation zone being defined by a partition and having a condenser duty, the partition preventing mass transfer between the first and second distillation zones proximate the partition;
g) providing at least a portion of the second distillation zone condenser duty from the first distillation zone through the partition;
h) contacting and separating ascending vapor and descending liquid in multiple vapor-liquid contacting stages in the second distillation zone;
i) passing liquid from the second distillation zone through a second conduit to the side draw stage; and
j) discharging an intermediate stream from the second distillation zone;

13. The method of claim 12 further comprising cooling at least a portion of the intermediate stream and returning at least a portion of the cooled intermediate stream to the second distillation zone.

14. The method of claim 12 wherein the vapor passing through the first conduit flows upwardly into the second distillation zone above the side draw stage.

15. The method of claim 12 further comprising obtaining at least 15% of the second distillation zone condenser duty from the first distillation zone.

16. The method of claim 12 further comprising obtaining at least 30% of the second distillation zone condenser duty from the first distillation zone.
